(19) United States
(12) Patent Application Publication
(10) Pub. No.: US 2007/0242279 A1
(43) Pub. Date: Oct. 18, 2007

(54) Device and method for the contactless measurement of at least one curved surface

(76) Inventors: Berthold Michelt, Wiesbaden (DE); Matthias Kunkel, Gelnhausen (DE); Christoph Dietz, Obertshausen (DE)

Correspondence Address: FACTOR & LAKE, LTD., Suite 5G/H, 1327 W. Washington Blvd., Chicago, IL, 60607, US

(21) Appl. No.: 11/787,099

(22) Filed: Apr. 12, 2007

(30) Foreign Application Priority Data
Apr. 13, 2006 (DE) 10 2006 017 400.3

(51) Int. Cl. G01B 11/24

(52) U.S. Cl. 356/609

(57) ABSTRACT

A device and a method for the contactless measurement of at least one curved surface. The device comprises at least one light source for generating light with a continuous spectrum, and a light exit face assigned to the light source. It furthermore has at least one measurement head having an optical imaging system with chromatic aberration for imaging the light exit face into wavelength-dependent focal planes, and an optical spectral instrument by which it is possible to record the spectral intensity distribution of light which is directed through the optical system onto the surface to be measured and is reflected therefrom. The device is furthermore equipped with an evaluation unit by which a distance between the optical system and the surface can be assigned to each wavelength at which the intensity distribution recorded by the optical spectral instrument has a local maximum. The surface to be measured is plane in one space direction. The optical axis of the optical system is perpendicular to the surface in this space direction. Furthermore, the width of the optical system is reduced perpendicularly to its optical axis in this space direction.

### RELATED APPLICATIONS

The present invention claims the benefit of the filing date of German Patent Application, Serial No. 10 2006 017 400.3, filed Apr. 13, 2006; the content of which is incorporated by reference herein.

### TECHNICAL FIELD

The present invention relates to a device for the contactless measurement of at least one curved surface, having at least a light source for generating light with a continuous spectrum, a light exit face assigned to the light source, a measurement head having an optical imaging system with chromatic aberration for imaging the light exit face into wavelength-dependent focal planes, an optical spectral instrument, by which it is possible to record the spectral intensity distribution of light which is directed through the optical system onto the surface to be measured and is reflected therefrom, and an evaluation unit by which a distance between the optical system and the surface can be assigned to each wavelength at which the intensity distribution recorded by the optical spectral instrument has a local maximum.

The present invention furthermore relates to a method for the contactless measurement of at least one curved surface, in which a light exit face with a continuous spectrum is produced, the light exit face is imaged by an optical system with chromatic aberration into wavelength-dependent focal planes, the spectral intensity distribution of light, which is directed onto the surface to be measured and is reflected therefrom, is recorded, and a distance between the optical system and the surface is assigned to each wavelength at which the recorded intensity distribution has a local maximum.

### BACKGROUND OF THE INVENTION

Known devices of this type are used particularly in order to determine layer thicknesses, in particular middle thicknesses of lenses. When constructed as scanning 3D measurement systems, they are moreover also used for the contactless measurement of topographies and profiles. Typical applications are quality assurance and manufacturing control in the glass, plastics, semiconductor and automobile industries, both in the laboratory and in industrial manufacturing.

A device of this type is described in an article by Matthias Kunkel and Jochen Schulze entitled “Mittendik-ke von Linsen berührungslos messen”, Photonik 6/2004. In order to measure the middle thickness of lenses, it is proposed therein to measure the distances between a fixed reference point and the vertices of the upper and lower sides of the lens. For the distance measurement, spectrally broadband light is coupled into an optical waveguide and fed via a fibre coupler to an objective with pronounced longitudinal chromatic aberration. The latter focuses the light emerging from the fibre end face wavelength-dependently onto the surface to be measured, where it generates a measurement spot with a diameter of a few micrometres. Sharp imaging of the illuminating fibre core, however, is obtained there only for a wavelength λ1. Reciprocally, the light with the same wavelength 11 is imaged sharply onto the fibre end and coupled back into the optical waveguide. Other wavelengths are strongly suppressed owing to the unsharp imaging. The reflected light travels via the fibre coupler into a spectrometer. The spectrum measured there shows a sharp peak at the relevant wavelength λ1. By calibration, the desired distance to the surface can be determined from the wavelength which is found. If two interfaces of a transparent material, in particular a lens, lie in the measurement range of the objective, then there are two wavelengths λ1 and λ2 for which sharp imaging is respectively obtained on one of the interfaces. Two peaks are correspondingly to be observed, from which the distances s1 and s2 to the two interfaces can be determined.

In order to achieve optimal measurement properties, in particular a high light sensitivity and a large resolving power, objectives of known measurement heads used for this purpose have a correspondingly large diameter for a correspondingly large aperture depending on the required measurement distance. The installation space for the measurement heads is however often limited in one space direction, particularly when a multiplicity of measurement heads are to be arranged in sequence with a small spacing. In this case, correspondingly narrow measurement heads would be desirable.

The present invention is provided to address these and other concerns.

### SUMMARY OF THE INVENTION

It is an object of the present invention to configure a device and a method of the type mentioned in the introduction, for which a measurement head can be used whose cross section has the smallest possible dimensions at least in one space direction and which has optimal measurement properties, in particular a high light sensitivity and a large resolving power.

This object can be achieved according to one embodiment of the present invention in that the surface to be measured is plane in one space direction and the optical axis of the optical system is perpendicular to the surface in this space direction and the width of the optical system is reduced perpendicularly to its optical axis in this space direction.

According to the present invention, the optical system is thus made narrow so that the entire measurement head is also narrower than the known measurement heads. In this way, in the space direction in which the optical system is narrower, the aperture of the optical system is in fact reduced perpendicularly to the optical axis relative to the aperture in the other space directions. The reduced diameter is nevertheless sufficient to achieve optimal measurement properties so long as the optical axis of the optical system extends essentially perpendicularly to the surface in the plane which is spanned by the optical axis of the optical system and the space direction of the reduced aperture. Overall, a large aperture is obviated in favour of the smaller outer dimensioning of the measurement head in the plane in which the optical axis extends perpendicularly to the surface to be measured, but without impairing the measurement properties. In the plane in which the surface is curved, on the other hand, the optical system has an aperture which is large enough to achieve optimal measurement results, and also correspondingly large dimensions.

In a particularly advantageous embodiment, the optical system may be a radially symmetric optical system with respect to its optical axis, in which a part is removed essentially parallel to its optical axis at least on one side. The removed part may in particular be sawed or ground off. In this way, the optical system retains its aperture and therefore its optimal measurement properties in the other lateral space directions.

Expediently, a part may respectively be removed on two opposite sides of the optical system. In this way, the measurement head is constructed symmetrically.

In order to be able to measure the surface in scanner fashion, the measurement head may be movable relative to the surface to be measured, in particular essentially perpendicularly to the space direction in which the width of the optical system is reduced.

The optical system may preferably be an objective, in particular a passive objective. With an objective, optimal imaging properties can be achieved. A passive optical system, which does not comprise any electronic or moving parts, is furthermore very robust and virtually insensitive to external, in particular mechanical and/or electrical effects.

In order to be able to conduct the light to the measurement head and away from it with the least possible losses, the measurement head may be connected via at least one optical waveguide, in particular a multimode optical waveguide, to the light source and the optical spectral instrument.

In a further particularly advantageous embodiment, a multiplicity of measurement heads may be arranged next to one another in the space direction in which the width of the optical system is reduced. In this way, the surface can be measured simultaneously and therefore very rapidly at a plurality of measurement points, which are arranged along a straight line in accordance with the measurement heads. Since the measurement heads are arranged close together on their narrow sides, it is possible to achieve a correspondingly small measurement point spacing and thus a large spatial resolution in this space direction. In order to measure the entire surface in scanner fashion, all the measurement heads may be moved simultaneously relative to the surface. The movement may take place perpendicularly to the space direction in which the measurement heads are narrow, or obliquely thereto.

Expediently, a thickness of at least one layer bounded by two surfaces, in particular a wall thickness, may be determinable by using the device. With the device, layer thicknesses of transparent, in particular at least partly cylindrical bodies, particularly glass or plastic bottles, can thus be determined simply and accurately.

The method is distinguished in that the optical axis of the optical system is aligned perpendicularly to the surface with respect to a space direction in which the surface to be measured is plane, the width of the optical system being reduced perpendicularly to its optical axis in this space direction.

Because the optical system is aligned in this way with respect to the surface, its optical axis extending perpendicularly thereto, a comparatively small aperture in this space direction is sufficient in order to measure with the same optimal measurement properties of the optical system. In this way, the measurement heads used can be made narrow. Overall, a large aperture is obviated in favour of the smaller outer dimensioning of the measurement head in the plane in which the optical axis extends perpendicularly to the surface to be measured.

It is to be understood that the aspects and objects of the present invention described above may be combinable and that other advantages and aspects of the present invention will become apparent upon reading the following description of the drawings and detailed description of the invention.

### BRIEF DESCRIPTION OF THE DRAWINGS

FIG. 1 schematically shows a side longitudinal section of a flattened measurement head;

FIG. 2 schematically shows the measurement head of FIG. 1 in plan view on one of its narrow sides;

FIG. 3 schematically shows the measurement head of FIGS. 1 and 2 in rear view;

FIG. 4 schematically shows a measurement head arrangement having three measurement heads of FIGS. 1 to 3 viewed from the side; and,

FIG. 5 schematically shows the measurement head arrangement of FIG. 4 in plan view when measuring the wall thickness of a glass cylinder.

### DETAILED DESCRIPTION OF THE INVENTION

While this invention is susceptible of embodiment in many different forms, there is shown in the drawings and will herein be described in detail one or more embodiments with the understanding that the present disclosure is to be considered as an exemplification of the principles of the invention and is not intended to limit the invention to the embodiments illustrated.

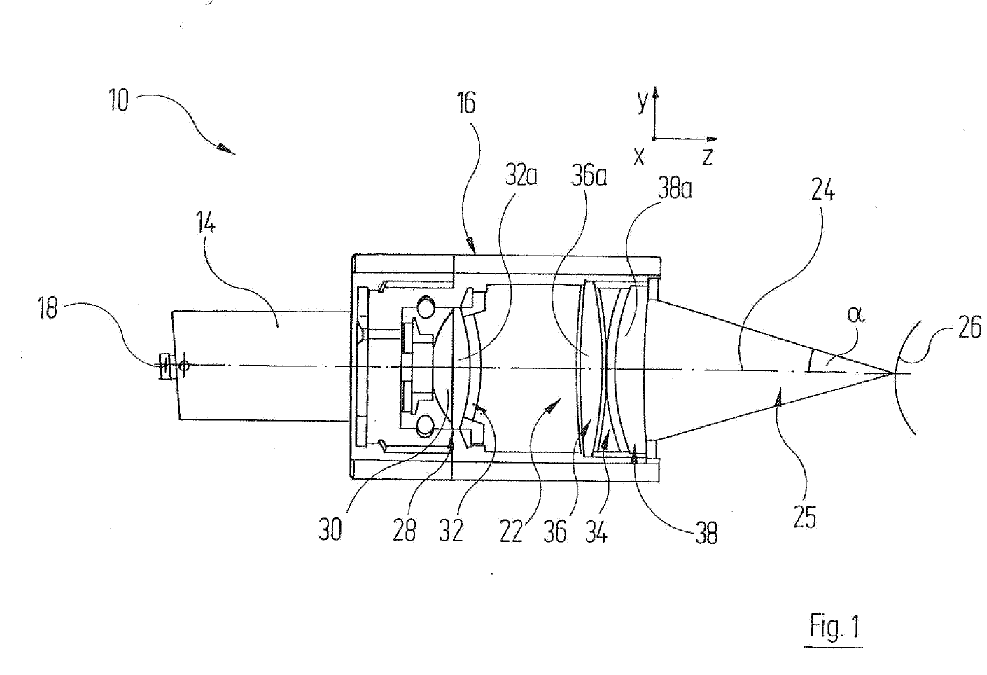

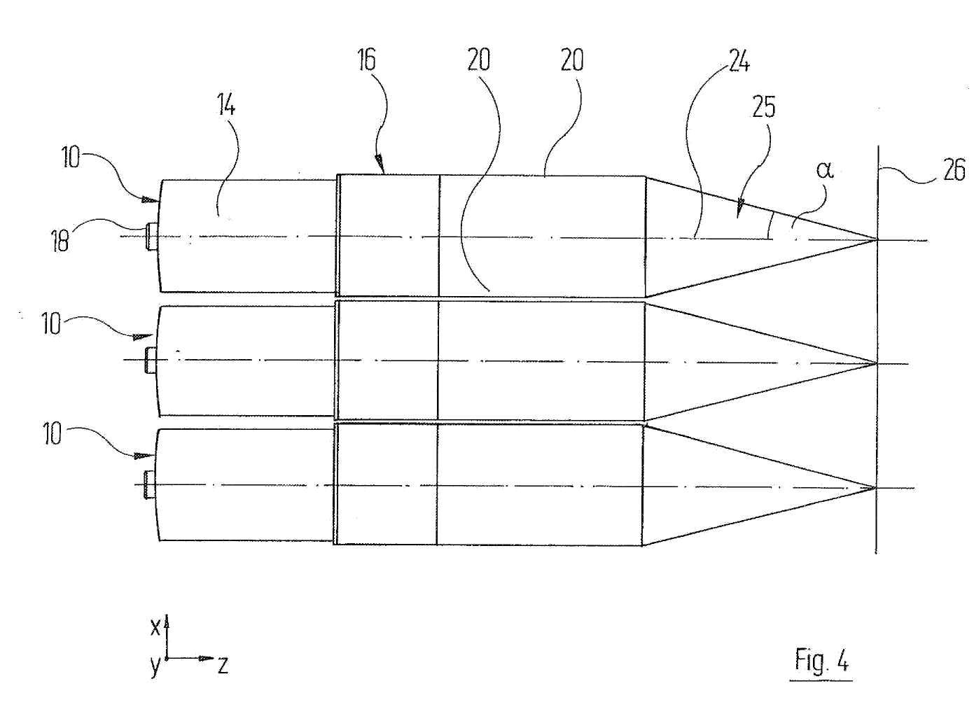

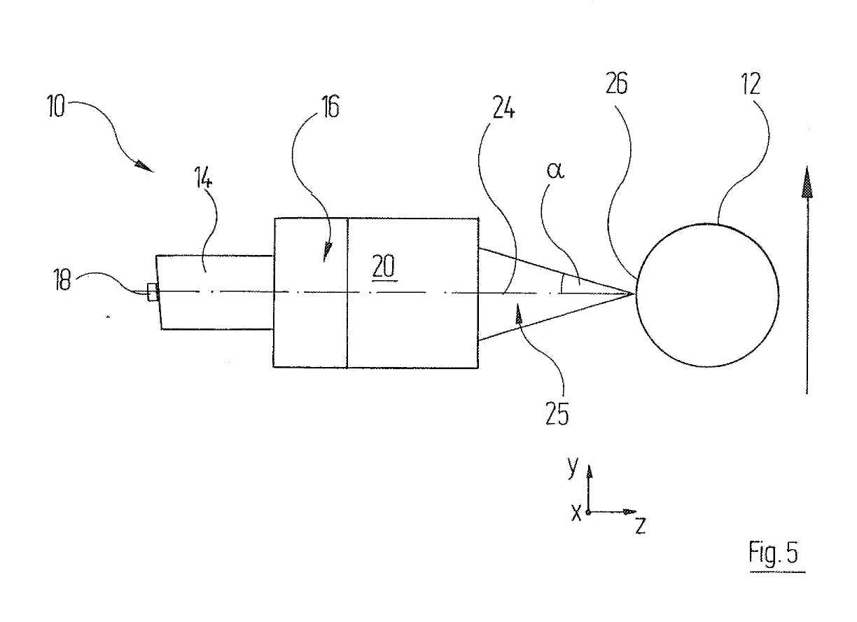

FIGS. 1 to 3 show an elongate measurement head, provided overall with the reference numeral 10, of a measurement head arrangement as shown in FIGS. 4 and 5 of a device (otherwise not represented) for contactless determination of the wall thickness of a glass cylinder 12, which is represented in FIG. 5.

The measurement head 10 is connected via a multimode optical waveguide (not shown) to a known light source for generating light with a continuous spectrum. The optical waveguide leads to a circular-cylindrical light guide connector body 14 on the rear end side of a housing 16 of the measurement head 10, on the left in the longitudinal section in FIG. 1. There, it opens into a fibre coupler 18 which is fastened centrally in the end face of the light guide connector body 14. The length of the measurement head 10 in the practical exemplary embodiment shown in FIGS. 1 to 5 is for example about 9 cm to 10 cm, and, with the light guide connector body 14, about 14 cm to 15 cm.

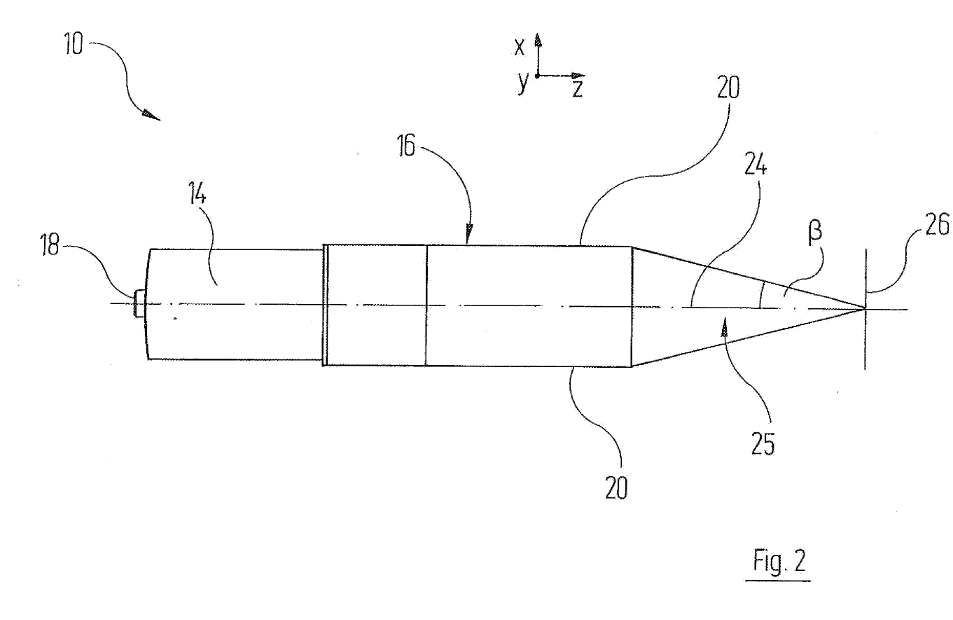

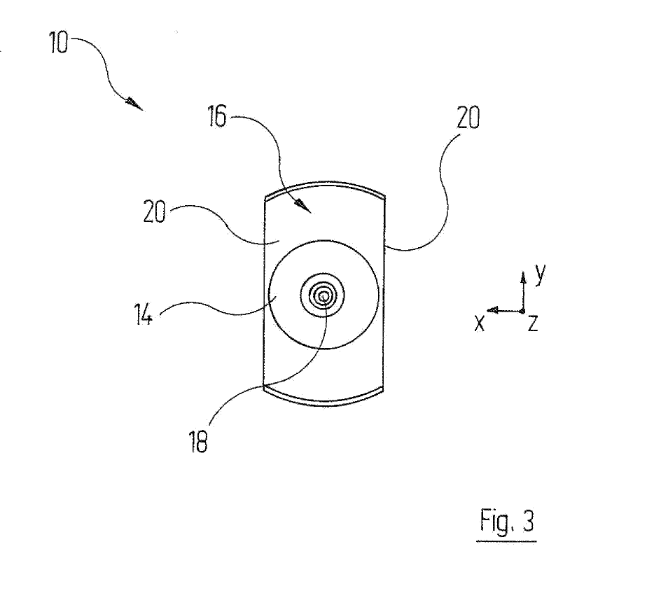

The housing 16 of the measurement head 10 has essentially the shape of a circular cylinder, the lateral surface of which is flattened on two mutually opposite sides 20, in FIG. 1 parallel to the plane of the drawing and horizontally in the plan view in FIG. 2 perpendicularly to the plane of the drawing; this can also be seen in the rear view in FIG. 3. The distance between the flattened sides 20 is somewhat greater than the diameter of the light guide connector body 14, as revealed by FIGS. 2 and 3. In the practical exemplary embodiment, the outer diameter of the housing 16 of the measurement body 10 is about 5 cm to 7 cm. The distance between the two flattened sides 20 is about 3 cm to 4 cm.

In the measurement head 10, the end of the optical waveguide acts as a light exit face (not visible in the figures) which is assigned to the light source, and which extends parallel to the end side of the housing 16 of the measurement head 10.

The measurement head 10 comprises an objective 22 with chromatic aberration, which images the light exit face on a reduced scale into wavelength-dependent focal planes, on the right of the measurement head 10 in FIG. 1. The optical axis 24 of the objective 22 extends coaxially with the housing 16 of the measurement head 10, horizontally in FIGS. 1, 2, 4 and 5, through the light exit face. A light cone for a wavelength selected by way of example is shown on the right in FIGS. 1, 2, 4 and 5. The height of the light cone 25 corresponds to a measurement distance of the objective 22 from a focal point, assigned to the cone tip, on the surface 26 to be measured belonging to the glass cylinder 12. The measurement distance in the practical exemplary embodiment is between 6.5 cm and 7.5 cm. The length of the objective 22 is for example about 5.5 cm to 6.5 cm.

As viewed from the light guide connector body 14, the objective 22 comprises a first lens pair 28 consisting of a planoconvex lens 30 and a planoconvex lens 32 and, at a distance therefrom, a second lens pair 34 consisting of a biconvex lens 36 and a concave-convex lens 38. The second lens pair 34 lies in the region of that end side of the measurement head 10 which faces the surface 26 to be measured, on the right in FIG. 1. The objective 22 is passive, i.e. it does not contain any electronic or moving parts.

The diameter of the objective 22 is reduced perpendicularly to its optical axis 24 in a space direction X, in accordance with the flattened sides 20 of the housing 16 of the measurement head 10. To this end, essentially parallel to the optical axis 24 of the objective 22, a part is respectively removed, for example sawed or ground off, on two mutually opposite sides of the lenses 32, 36 and 38 which originally are radially symmetric with respect to the optical axis 24, so that the lenses 30, 32, 36 and 38 respectively have flattened side faces 32a, 36a and 38a there. The lens 30 has a significantly smaller diameter than the other lenses 32, 36 and 38, and therefore needs no reduction. By removing the lateral lens parts, the aperture of the objective 22 is reduced in the corresponding lateral space direction X, i.e. extending perpendicularly to the optical axis 24, relative to the original aperture which still exists in a lateral space direction Y perpendicular thereto. In FIGS. 1, 2, 4 and 5, the aperture differing in the mutually perpendicular lateral space directions Y and X is illustrated with the aid of the corresponding profile of the light cone 25. In the plane of the broad side of the objective 22 and of the measurement head 10, in FIG. 1, an angle α of for instance 17° between the optical axis 24 and the lateral cone surface of the light cone 25 is significantly greater than a corresponding angle β in the plane of the narrow side of the objective 22 and of the measurement head 10, in FIG. 2, where it is for instance 15°.

The measurement head 10 is furthermore connected in the known way via a splitter (not shown), known from the prior art, in the optical waveguide to a spectrograph (likewise not represented). With the spectrograph, it is possible to record the spectral intensity distribution of light which is directed through the objective 22 onto the surface 26 to be measured and is reflected therefrom.

The device furthermore has an evaluation unit (not shown), which is functionally connected to the spectrograph. By the evaluation unit, a distance between the objective 22 and the surface 26 to be measured can be assigned to each wavelength at which the intensity distribution recorded by the spectrograph has a local maximum.

FIG. 4 shows the measurement head arrangement consisting of three identical measurement heads 10. The measurement heads 10 are arranged in the space direction X in which the widths of their objectives 22 are reduced, above one another in FIG. 4. Since the measurement heads 10 are narrow, their optical axes 24, and therefore the focal points which provide the measurement points, lie very close together so that a correspondingly large resolution is produced in the space direction X.

In FIG. 5, the measurement heads 10 of FIG. 4 are shown in plan view looking onto their broad sides. Only the upper measurement head 10 is visible here, the others being covered by it.

In order to measure the wall of the glass cylinder 12, the measurement heads 10 are aligned so that the width of their objectives 22 is reduced in the space direction X, in which the wall's surface 26 to be measured is straight, i.e. parallel to the axis of the glass cylinder 12. The axis of the glass cylinder 12 extends perpendicularly to the plane of the drawing in FIG. 5. The optical axis 24 then lies in the plane in which the measurement heads 10 are narrow, perpendicularly to the surface 26.

In order to measure the wall thicknesses of the glass cylinder 12, it is guided perpendicularly to the optical axes 24 of the objectives 22 in the space direction Y, from the bottom upwards in FIG. 5, along the measurement heads 10 on the light exit side. The measurement heads 10 are thus moved relative to the surface 26 to be measured, essentially perpendicularly to the space direction X in which the width of the objective 22 is reduced. The cylinder wall is straight in the space direction X, here parallel to the axis of the glass cylinder 12, in which the objectives 22 have a small aperture. The shortest distance between the wall of the glass cylinder 10 and the measurement heads 10 when the glass cylinder 12 is moved past corresponds approximately to the average measurement distance of the objective 22, so that the wall's inner surface (surface 26) and the wall's outer surface can respectively be assigned to one of the focal planes achievable by the measurement heads 10 when the wall's side facing the measurement heads 10 passes. As the glass cylinder 12 passes, two peaks are then simultaneously recorded via each of the measurement heads 10 by the respective spectrograph, and the corresponding distances to the wall's inner and outer surfaces, and from this the wall thickness of the glass cylinder 12, are determined by the evaluation instrument.

Instead of the objective 22, another type of optical imaging system with chromatic aberration may be provided.

Instead of the spectrograph, another optical spectral instrument may also be used, for example a spectrometer.

Instead of on both sides 20, a part of the lenses 3, 36 and 38 may also be removed only on one side.

Instead of perpendicularly to the space direction in which the width of the objective 22 is reduced, the measurement heads 10 may also be moved obliquely thereto.

Instead of a passive objective 22, for example, a manually or automatically adjustable objective may also be used.

The device is not restricted to the determination of a thickness of a wall. Rather, it may be used for determining a thickness of any layer, bounded by two surfaces, of a transparent body. This may even involve internally lying layers.

Instead of the surface 26 of a glass cylinder 12, it is also possible to measure other curved surfaces which are plane in at least one space direction, including for example bottles, cones or pyramids.

The device, in particular the measurement head 10, may also be used as a high-resolution distance sensor. It may also be configured as a scanning 3D measurement system for the contactless measurement of topographies and profiles, even of non-transparent surfaces.

The dimensions of the measurement heads 10, the measurement distances and the angles α and β indicated for the light cone 25 may be significantly greater or less than those indicated by way of example.

It is to be understood that additional embodiments of the present invention described herein may be contemplated by one of ordinary skill in the art and that the scope of the present invention is not limited to the embodiments disclosed. While specific embodiments of the present invention have been illustrated and described, numerous modifications come to mind without significantly departing from the spirit of the invention, and the scope of protection is only limited by the scope of the accompanying claims.

1. A device for the contactless measurement of at least one curved surface, the device comprising:
a light source for generating light with a continuous spectrum;
a light exit face assigned to the light source;
a measurement head having an optical imaging system with chromatic aberration for imaging the light exit face into wavelength-dependent focal planes;
an optical spectral instrument, by which it is possible to record the spectral intensity distribution of light which is directed through the optical system onto the surface to be measured and is reflected therefrom;
and an evaluation unit by which a distance between the optical system and the surface can be assigned to each wavelength at which the intensity distribution recorded by the optical spectral instrument has a local maximum,
wherein the surface to be measured is plane in one space direction and the optical axis of the optical system is perpendicular to the surface in this space direction and the width of the optical system is reduced perpendicularly to its optical axis in this space direction.

2. The device of claim 1, wherein the optical system is a radially symmetric optical system with respect to its optical axis, in which a part is removed essentially parallel to its optical axis at least on one side.

3. The device of claim 2, wherein a part is respectively removed on two opposite sides of the optical system.

4. The device of claim 1, wherein the measurement head can be moved relative to the surface to be measured.

5. The device of claim 1, wherein the optical system is an objective.

6. The device of claim 1, wherein the measurement head is connected via at least one optical waveguide, to the light source and the optical spectral instrument.

7. The device of claim 1, wherein a multiplicity of measurement heads are arranged next to one another in the space direction in which the width of the optical system is reduced.

8. The device of claim 1, wherein a thickness of at least one layer bounded by two surfaces, can be determined by using it.

9. A method for the contactless measurement of at least one curved surface, in which a light exit face with a continuous spectrum is produced; the light exit face is imaged by an optical system with chromatic aberration into wavelength-dependent focal planes; the spectral intensity distribution of light, which is directed onto the surface to be measured and is reflected therefrom, is recorded; and a distance between the optical system and the surface is assigned to each wavelength at which the recorded intensity distribution has a local maximum; wherein the optical axis of the optical system is aligned perpendicularly to the surface with respect to a space direction in which the surface to be measured is plane, the width of the optical system being reduced perpendicularly to its optical axis in this space direction.
